(19) United States
(12) Patent Application Publication
(10) Pub. No.: US 2007/0038969 A1
(43) Pub. Date: Feb. 15, 2007

(54) Electronic ultimate defects analyzer detecting all defects in pcb/mcm

(75) Inventors: Yizhak Pitkary, Natanya (IL); Jacob Gitman, Rehovot (IL); Yair Dankar, Kfar Saba (IL)

Correspondence Address: BRUCE E. LILLING;LILLING & LILLING P.C., P.O. BOX 560, GOLDEN BRIDGE, NY, 10526, US

(73) Assignee: INVISIBLE LTD, Rehovot (IL)

(21) Appl. No.: 10/595,166

(22) PCT Filed: Sep. 14, 2004
(86) PCT No.: PCT/IL04/00842

§ 371 Date: Mar. 15, 2006

Related U.S. Application Data
(60) Provisional application No. 60/502,941, filed on Sep. 16, 2003.

(51) Int. Cl. G06F 17/50

(52) U.S. Cl. 716/4

(57) ABSTRACT

A system for electric testing PCB/MCM before and after assembly. The system uses energy taken from a heating source, timely applied at certain ports of the PCB/MCM (entry ports). The energy is defused through the board inner layer tracks terminating at the end of the channel tracks of the PCB/MCM (exit ports). The rate of energy diffusion on the board is measured at the terminating ports in the time domain. The thermal emission is measured by a spectrometer that conducts infrared scans and analyzes the PCBs energy spectrum. Measurements can be taken as discrete measurements or as integrated measurements. The measurements results are compared with the pre-memorized values of a group of patterns that represent respective golden board. Defect analysis is automatically achieved based on learned defect test patterns.

### BACKGROUND OF THE INVENTION

The present invention relates to the field of PCB/MCM testing technologies and methods following bare PCB/MCM production process as well as assembled boards/MCM base material. More precisely it is a PCB/MCM defects detection system using thermal diffusion technology.

At present, there are two major methods for electrically testing printed circuit boards (PCB), the traditional ‘bed of nails method’ and the ‘flying probe method’. The bed of nails is a resistance measurements method comprised of springy pins which are electrically connected to pads on the PCB/MCM. During the test signals are applied to some of the nails, and measurements are taken at other nails. The bed of nails device needs to be especially designed, built and programmed to fit the structure of the tested PCB/MCM type. Each PCB/MCM needs a different device.

The flying probe method is based on moving pair(s)' probes physically from one point to another, touching the board and conducting the same tests made by the bed of nails but sequentially. This method eliminates the need to build the physical element required by the bed of nails method, but it still requires making physical contact with the board while conducting electrical tests. Bed of nail tests is limited to a minimum pitch size of 600 micrometer. The method of testing PCBs by flying probe is limited to a minimum pitch size of 300 micrometer. For bed of nail the test time can take between 1 and 2 minutes per PCB/MCM, for flying probes the test time is more than two hours. There is therefore a need for a PCB/MCM testing method which does not require making physical contact with the board, thus decreasing the pitch size limit and decreasing the testing time considerably and improving the tests' reliability.

Patent application No. WO 02/48720 and U.S. patent application Ser. No. 10/419,709 which is a continuation in part of U.S. patent application Ser. No. 09/986,712 by Schlagheck et al. disclose a method and apparatus for inspecting an object and detecting defects (BGA and Flip-Chip solder joints on a PCB particularly). The method according to these applications comprises injecting a thermal stimulation on the object, capturing a sequence of consecutive infrared images of the object to record heat diffusion resulting from the heat pulse. Comparing the heat diffusion on said object to a reference and determining whether the object comprises any defects. The method is limited for detecting anomalies in solder junctions of ball-grid arrays and flip chips mounted on printed circuit boards.

The primary object of the present invention is to provide a method and apparatus for inspecting an object and detecting defects in PCBs inner layer tracks and surface layer conductors by analyzing the time interval and components of the spectral emission.

It is a further object of the present invention to perform anomaly tests like continuity, trace resistance, current leakage and impedance control. It can also perform tests that will represent high voltage tests.

### THE OBJECT OF THE INVENTION

The object of the invention is to build a PCB/MCM electric test system that will not require any physical contact between the testing device and the board. This method will significantly increase the speed of testing (hundred time and more), will enable testing 5 micron pitch complicated boards and will significantly increase the reliability of the test. The system can test continuity, trace resistance, detect current leakage, impedance control and perform tests that will represent high voltage tests.

### SUMMERY OF THE INVENTION

A method for testing PCB or MCM (DUT), by checking energy diffusion through boards tracks, said method is comprised of applying heat energy at entrance ports of the PCB/MCM then measuring in time domain the rate of energy diffusion along the tracks of the board at the terminating ports. The measurements are compared with pre-memorized values of a group of patterns that represent respective golden board results and analyzing defects automatically on the basis of learned defect test patterns.

The method of the measurement can be conducted in different frequencies bands and can be consecutive, heating a single port at a time, or more than one port simultaneously. The heating process duration is determined in accordance with the heating source type and DUT material.

A system for testing PCB/MCM or MCM (DUT), by checking energy diffusion through boards tracks, said method is comprised of controlled heat energy source for applying heat at certain ports of the PCB/MCM (entry ports), thermal Imaging means for measuring in time domain the rate of energy diffusion along the tracks of the board at terminating ports and processing means for comparing said measurements with pre-memorized values of a group of patterns that represent respective golden board results and analyzing defects automatically on the basis of learned defect test patterns.

The system include spectral image means wherein the measurement can be conducted in different frequencies bands, consecutive, heating a single port at a time or more than one port simultaneously. The heating process duration is determined in accordance with the heating source type and DUT material.

The system analysis process enables to identify the defect type according to its respective pattern.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein—

FIG. 1 illustrates the typical defects detection analysis methods.

FIG. 2-FIG. 5 illustrates several examples for different kinds of PCB/MCM defects.

FIG. 6 illustrates a track model surrounded by a bounding box, with a gap and without one.

FIG. 7 illustrates the PCB/MCM thermal modeling graph for golden board and defected one.

FIG. 8 is the system's flow chart.

FIG. 9 is the system's block diagram.

### DETAILED DESCRIPTION OF THE INVENTION

Introduction

The fundamental physical law which we employ here is the law of conservation of energy. Consider a thin, rigid, heat-conducting body (a bar) of length l.

Let θ(x, t) indicate the temperature of this bar at position x and time t, where 0≦x≦l and t≧0.

In other words, we postulate that the temperature of the bar does not vary with the thickness. We assume that at each point of the bar the energy density per unit volume is proportional to the temperature.

We assume that the surface of the bar is perfectly insulated so no heat can be gained or lost through it, except of the input and output ports.

It says that the rate of change of energy in any finite part of the bar is equal to the total amount of heat flowing into this part of the bar.

This equation is known as the “heat equation”, and it describes the evolution of temperature within a finite, one-dimensional, homogeneous continuum, with no internal sources of heat, subject to some initial and boundary conditions:

$$\frac{\partial θ}{\partial t} = γ \frac{{\partial }^{2} θ}{\partial {x}^{2}} , 0 < x < l$$

$$γ = \frac{k}{c}$$

γ is known as the diffusion coefficient, Heat capacity c(x) and the thermal conductivity k(x) are point independent.

We assume that the PCB/MCM conductors are finite, one-dimensional, homogeneous continuum and perfectly insulated bars but we can change this assumption, considering that the channel is not perfectly insulated, by changing the “Heat Equation” respectively.

Solving the heat equation for the PCB/MCM conducting tracks, we conclude that the rate at which heat flows through the track at position x and time t, depend on the quality and characteristic of the track. Damage or a defect along the track will cause a change in the density of the material and in the diffusion coefficient, leading to a change in the rate of the heat flow. So any physical change in the track will lead to a change in the time interval of the heat equilibrium between both ends of the track.

Heat is another form of energy. When an object is being heated its particles move faster and the molecules are vibrating at a range of frequencies (energy spectrum), depending on the substance and the shape of the object.

The system performs spectral analysis of the heat energy emitted from the end of the track and any damage or a defect along the track will cause a change in the frequency components of the energy spectrum.

Test Method

The entrance ports of the PCB/MCM tracks are illuminated, causing heat transfer along the tracks. The entrance ports are beamed selectively or mutually by a regular light source or a laser beam. The temperature rise at the entrance ports is affected by the illumination duration, in compliance with the PCBs material specifications and the heat source. PCB/MCM tracks are made of copper with some degree of contamination. As a result of the heating process at the entrance ports, a heat wave propagates along the track. The heat is diffused along the tracks and the exit ports. For analyzing the diffusion at the exit port of the track, the respective diffusion equation (heat equation) for the specific material is applied using the respective diffusion coefficient. The rate of the diffusion along the tracks depends on the diffusion coefficient. This coefficient value for the specific material is proportional to the heat conduction coefficient, and inverse-proportional to the density of the material and the heat intensity.

This rate of diffusion along the tracks depend also on the initial conditions (rate of change of the temperature at the end ports of the track) as well as on the initial conditions which indicate what was the temperature at t=O along the track.

The results of rise in temperature at exit port/s, occur in time delay with respect to temperature rise at the entrance port. The temperature measurement with respect to time at the exit port/s is a crucial parameter for the analysis. The radiant flux emitted from the exit port is also wavelength dependent and proportional to the emissivity of the specific copper track. Emissivity of metals is proportional to their density and inverse-proportion to their temperature. The analysis of the exit ports is performed by using an infrared spectrometer and a thermal imaging apparatus. The measurements are taken with respect to a time domain at a specific wavelength or with respect to a time domain and an integration of the whole spectral emission. Any existing defect along the track will affect the heat diffusion along the track and cause time domain changes in thermal characteristics at the exit port. During the manufacturing process of the device, it is initially calibrated both for defect free tracks and for tracks which exceeds predetermined tolerance (as defined by the net-list IPC-D350/356). The data obtained from the calibration process is used as reference for detecting defects on the board.

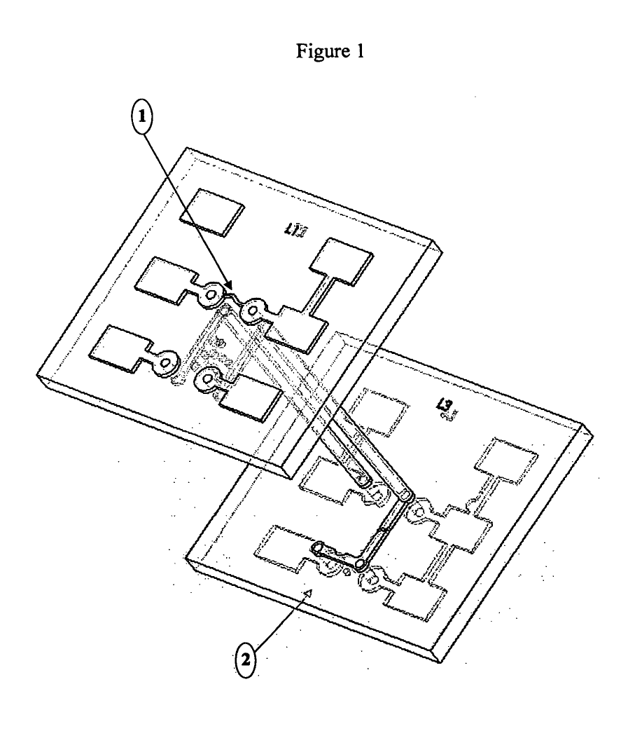

FIG. 1 illustrates the structure of the PCB/MCM: layers and tracks. (1) Upper (L1) and (2) lower (L4) layers can be equally treated as input or readout layer, individually or simultaneously.

According to the present invention, the method can detect and identify the following electrical phenomena:

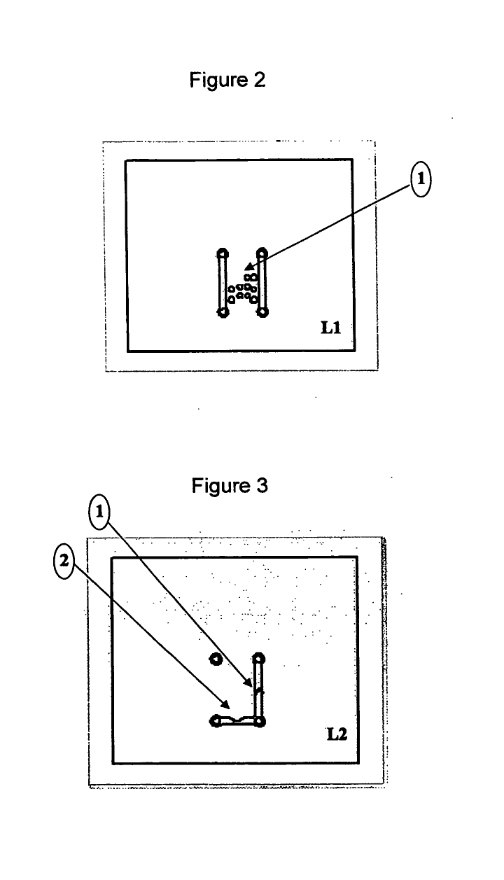

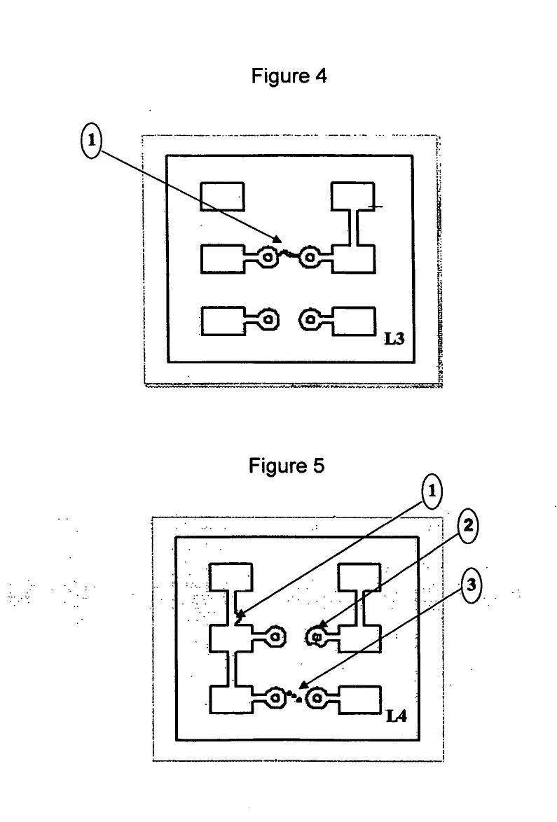

Irregular impedance, Current leakage, Voltage breakthrough, Continuity test: Short/Open and out of range Resistance between traces or layers and also between planes. Several types of defects detected are indicated in FIG. 2, FIG. 3, FIG. 4 and FIG. 5.

FIG. 2 illustrates the upper layer (L1) of the PCB/MCM. It describes one of the most common defects, a Shortage (1) between channels.

FIG. 3 illustrates the second layer (L2) of the PCB/MCM. It demonstrates how the existence of residues can cause current leakage (1) between channels and low resistance.

FIG. 4 illustrates the third layer (L3) of the PCB/MCM. It describes a thick copper conductor (1) that causes low ohm resistance, an ‘eaten’ via (2) that lead to high ohm resistance and Breakthrough/leakage (3) caused by existence of residues between pads.

FIG. 5 illustrates the forth layer (L4) of the PCB/MCM. It indicates an Open channel (1) caused by etching malfunction due to unclear photo resist—Reston and Low resistance (2) caused by etching malfunction due to unclear photo resist—Reston.

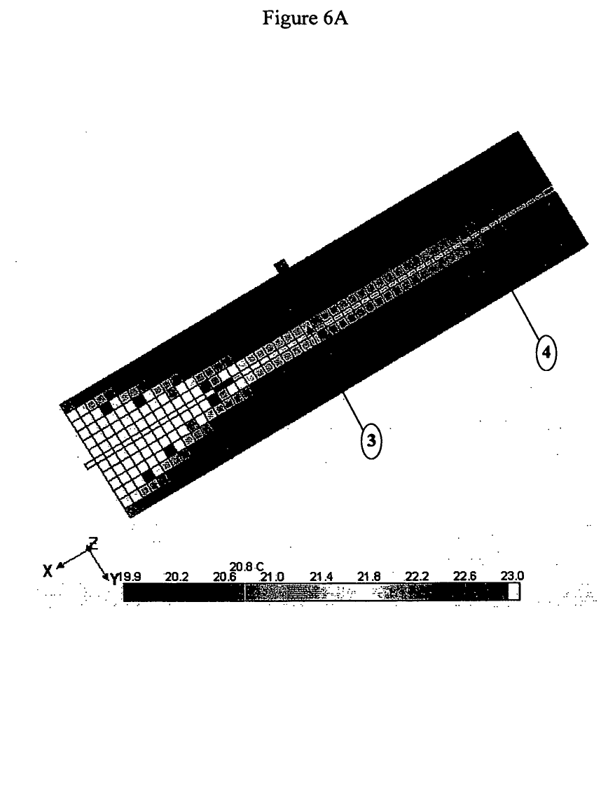

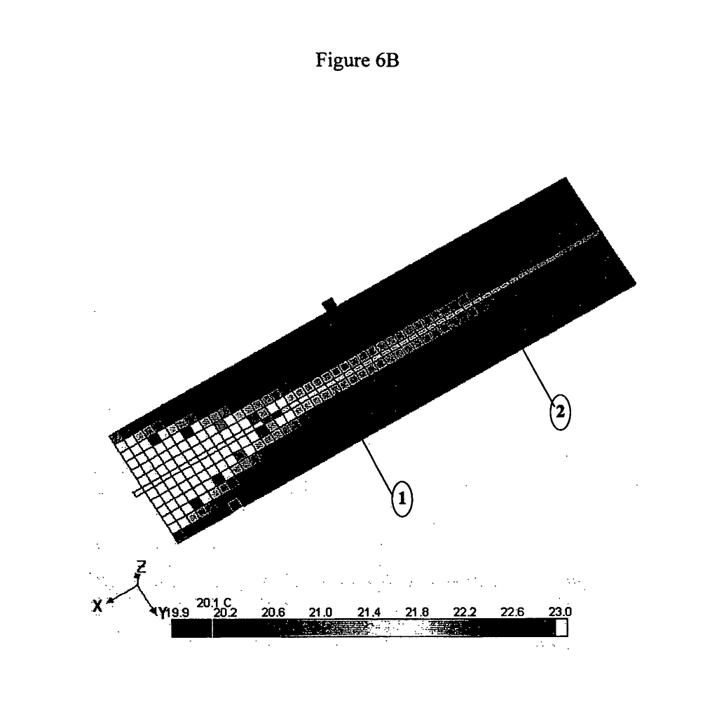

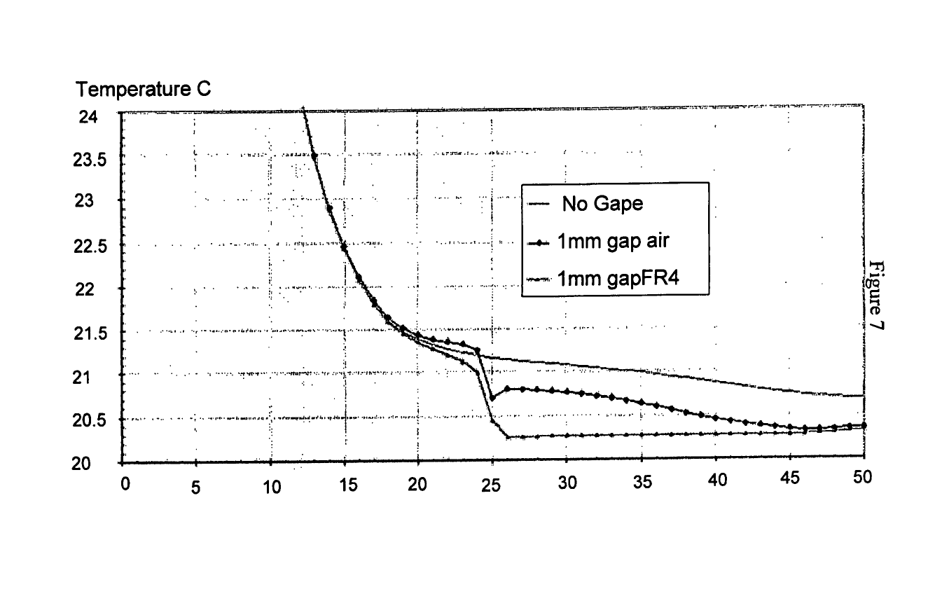

FIG. 6 illustrates the gap influence on the PCB/MCM surface temperature distribution along the central line. The simulated PCB illustrates how a gap in the track causes a change in the diffusion rate when Comparing (1) to (3) and (2) to (4). The difference of temperatures between a golden board and a defect PCB is quite obvious.

FIG. 7 illustrates a graph of the simulation of a break in a track which shows the temperature as a function of the distance from the heat source at a specific time (0.4 seconds), the heat diffusion graph of the gap is compared to a graph of a perfect track. The gap in the track is filled with air or FR4 causing heat distribution along the central line to be different from a golden board. The type material found in the gap influence the response of the heat distribution.

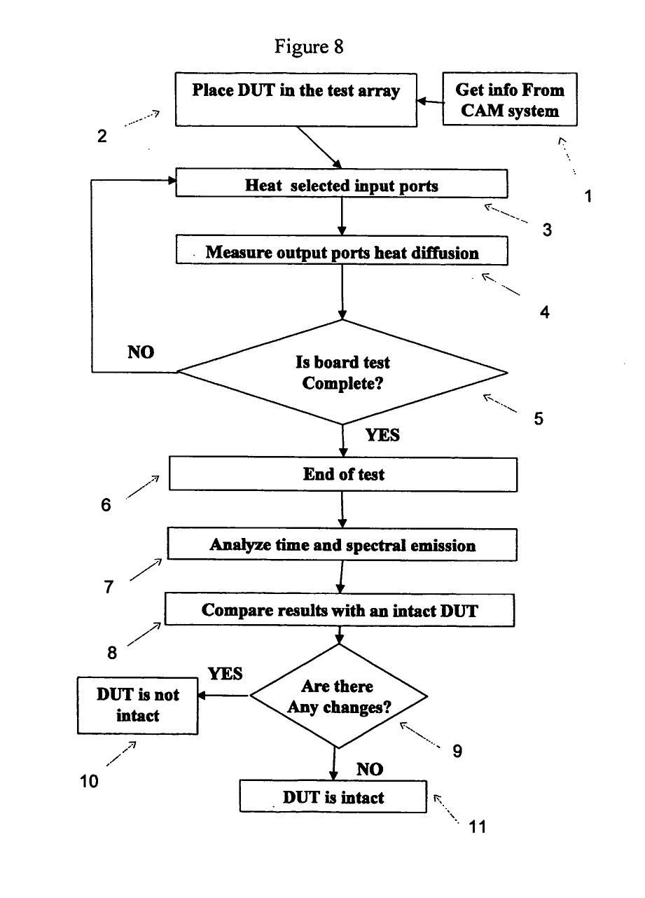

FIG. 8 illustrates the flow chart of the test procedure. First the testing system receives the PCB/MCM datum from the CAM (computer aided manufacturing) system (step 1), then the DUT (device under test—i.e. PCB) is placed in the test array (step 2) and the entrance ports of the PCB/MCM tracks are illuminated (step 3), causing heat transfer along the tracks.

At the next step (4), temperature measurement are taken as a function of time at the exit in a serial mode (one port at a time) or in a parallel mode (altogether). Additionally spectral emission pattern measurements are also being conducted at the exit port or ports.

The test procedure can include a number of stages, depends on whether the entrance ports are beamed selectively or mutually. After each stage, the system examines (step 6) if it has finished checking all the tracks and continues until all tracks were tested.

The test results (diffusion time and spectral emission) are analyzed (step 8) after the test is completed. The system then compares (step 9) the test obtained datum with datum that was initially obtained from the calibration process for defect free tracks and for tracks which exceeds determined tolerance.

The system can detect and identify several electrical phenomena like Irregular impedance, Current leakage and Voltage breakthrough.

If the changes between the DUT and the referenced PCB/MCM are outside the tolerance boundaries, the tested PCB/MCM is considered damaged and unfit for use (step 10) otherwise the PCB/MCM is fully intact and ready for use (step 11).

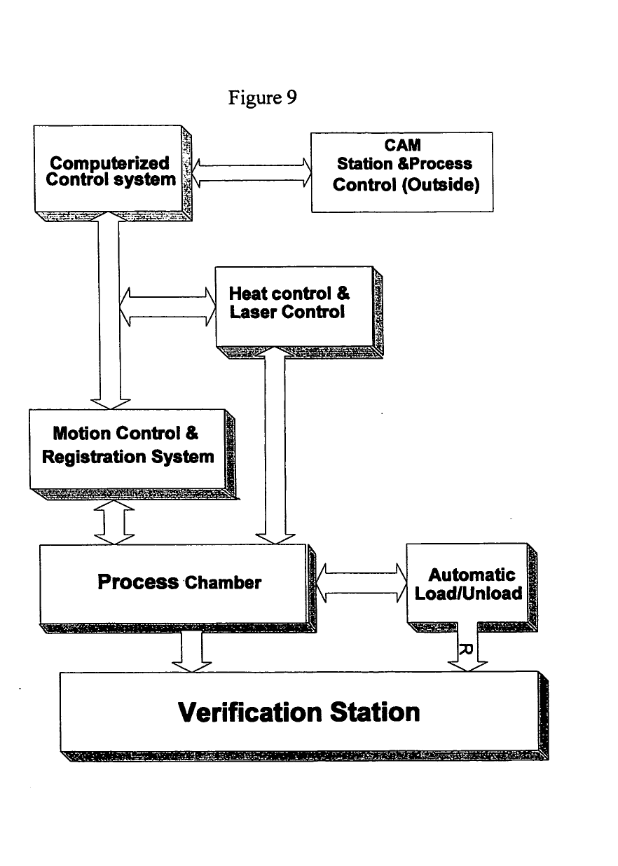

FIG. 9 illustrates the block diagram of the test procedure. The entire electric test system is connected to the CAM (computer aided manufacturing) system. The CAM system provides the specifications of the particular PCB/MCM (i.e. DUT) that undergoes the test procedure, to the computerized control system (CCS). The CCS controls the heating source (e.g. laser) used for illuminating the input ports and the motion control. The PCB/MCM is placed in the process chamber by the automatic load/unload unit and undergoes the process of diffusing energy through the board inner layer tracks terminating at the end of the channel tracks. The raw results are recorded, analyzed and compared to a golden board (pre analyzed or simulated one) in the verification process.

Heating Sources

The heating source apparatus may be a xenon flash lamp, incandescent lamp, laser, LED, arc lamps or any other light source that fits the testing requirements. The type of heating source is selected according to several criteria like the illumination of the tracks, the duration of the illumination and the use of collimating optics between the source and the entrance ports.

The illumination of the tracks entrance ports is preformed either simultaneously or one at a time and the duration of the illumination can vary from several milliseconds to several seconds in accordance with heating source type and PCB/MCM material.

Test Process Workflow and Analysis

The testing procedure at the exit ports changes according to the analysis measuring method. An infrared spectrometer via collimating optics is used to analyze the temperature of each exit port with respect to time and wavelength.

The same method can be utilized by checking a spectral window with respect to time instead of a single wavelength. A different procedure uses a thermal imaging device to analyze each or all exit ports simultaneously. Any combination of the aforementioned different methods can be used.

Test results of the exit ports are compared to a database of an identical perfect track.

“Thermal pictures” is a known technology in the context of software for picture analysis. The present invention is based on thermal conduction of copper, or any other metal or mixture of metals of which the track is made of and the analysis of the temperature through the infrared emission at the edges (exit ports of the tracks). Defects along the tracks will affect the heat conduction and therefore will change the thermal picture at the exit port. These defects ultimately change the spectral emission at the exit ports. The analysis of the spectrum with respect to time enables spotting and identifying those defects and their severity.

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for testing PCB or MCM (DUT), by checking energy diffusion through boards tracks, said method comprising the steps of:
A. Applying heat energy at entrance ports of the PCB/MCM.
B. Measuring in time domain the rate of energy diffusion along the tracks of the board at the terminating ports.
C. Comparing said measurements with pre-memorized values of a group of patterns that represent respective golden board results.
D. Analyzing defects automatically on the basis of learned defect test patterns.

2. The method of claim 1 wherein the measurement is conducted in different frequencies bands.

3. The method of claim 1 wherein the DUT is before assembly.

4. The method of claim 1 wherein the DUT is after assembly.

5. The method of claim 1 wherein the measurements are consecutive, heating a single port at a time.

6. The method of claim 1 wherein the measurements are conducted at more than one port simultaneously.

7. The method of claim 1 wherein analysis process enable to identify the defect type according to the respective pattern.

8. The method of claim 1 wherein the heat is applied simultaneously at different entrance ports.

9. The method of claim 1 wherein the heating process duration is determined in accordance with the heating source type and DUT material.

10. The method of claim 1 wherein the golden board is a pre analyzed perfect PCB/MCM.

11. The method of claim 1 wherein the golden board is a simulated PCB/MCM.

12. A system for testing PCB or MCM (DUT), by checking energy diffusion through boards tracks, said method comprising the steps of:
A. Controlled heat energy source for applying heat at certain ports of the PCB/MCM (entry ports).
B. Thermal Imaging means for measuring in time domain the rate of energy diffusion along the tracks of the board at terminating ports.
C. Processing means for comparing said measurements with pre-memorized values of a group of patterns that represent respective golden board results and analyzing defects automatically on the basis of learned defect test patterns.

13. The system of claim 12 further including spectral image means wherein the measurement is conducted in different frequencies bands.

14. The system of claim 12 wherein the DUT is before assembly.

15. The system of claim 12 wherein the DUT is after assembly.

16. The system of claim 12 wherein the measurements are consecutive, heating a single port at a time.

17. The system of claim 12 wherein the measurements are conducted at more than one port simultaneously.

18. The system of claim 12 wherein the measurement include thermal map.

19. The system of claim 12 wherein analysis process enable to identify the defect type according to its respective pattern.

20. The system of claim 12 wherein the heat is applied simultaneously at different entrance ports.

21. The system of claim 12 wherein the heating process duration is determined in accordance with the heating source type and DUT material.

22. The system of claim 12 wherein the golden board is a pre analyzed perfect PCB/MCM.

23. The system of claim 12 wherein the golden board is a simulated PCB/MCM.
